(19) United States
(12) Patent Application Publication
(10) Pub. No.: US 2013/0182145 A1
(43) Pub. Date: Jul. 18, 2013

(54) IMAGING DEVICE

(71) Applicant: Panasonic Corporation, Osaka (JP)

(72) Inventors: Kyosuke Osuka, Osaka (JP); Katsuyuki Tamai, Kyoto (JP); Yoshiyasu Kado, Nara (JP)

(73) Assignee: Panasonic Corporation, Osaka (JP)

(21) Appl. No.: 13/737,045

(22) Filed: Jan. 9, 2013

(30) Foreign Application Priority Data
Jan. 12, 2012 (JP) 2012-003720

(51) Int. Cl. H04N 5/232

(52) U.S. Cl. CPC H04N 5/232
USPC 348/231.3

(57) ABSTRACT

An imaging device includes an imaging component, a position acquisition component, an attribute image data acquisition component, and a recorder. The imaging component is configured to capture a subject and output captured image data. The position acquisition component is configured to acquire a position of the subject, the subject being captured at the position. The attribute image data acquisition component is configured to acquire map image data as attribute image data from a map database, the map image data including the position of the subject. The recorder is configured to record the captured image data and the attribute image data in one file.

### CROSS-REFERENCE TO RELATED APPLICATIONS

This application claims priority under 35 U.S.C. §119 to Japanese Patent Application No. 2012-003720 filed on Jan. 12, 2012. The entire disclosure of Japanese Patent Application No. 2012-003720 is hereby incorporated herein by reference.

### BACKGROUND

1. Technical Field The technology disclosed herein relates to an imaging device with which a captured image is recorded such that the captured image is associated with ancillary data related to the captured image.

2. Background Information A digital camera is capable of capturing and recording images of a subject. The digital camera records captured still or moving pictures by adding ancillary data indicating attributes of the images (see Japanese Laid-Open Patent Application H7-64169, for example).

A conventional digital camera has a GPS (global positioning system) function. With this digital camera, information is acquired about the position of the digital camera when an image is captured, and this position information is recorded as ancillary data along with the image. This allows the imaging position to be recorded when the image was captured.

A conventional digital camera can record position information along with images. However, a problem was that it was difficult to ascertain the imaging position during reproduction if the longitude and latitude or place names are merely displayed. Meanwhile, it is also possible to connect to a network and download and display a map of the area around the imaging position. A problem, however, is that a map of the area around the imaging position cannot be displayed if the digital camera is not designed for connection to a network or is not in the right environment.

This disclosure was conceived in light of the above problems, and provides an imaging device with which the imaging position can be easily ascertained. This disclosure also provides an imaging device with which the imaging position can be easily ascertained without connecting to a network.

### SUMMARY

The imaging device disclosed herein comprises an imaging component, a position acquisition component, an attribute image data acquisition component, and a recorder. The imaging component is configured to capture a subject and output captured image data. The position acquisition component is configured to acquire a position of the subject, the subject being captured at the position. The attribute image data acquisition component is configured to acquire map image data as attribute image data from a map database, the map image data including the position of the subject. The recorder is configured to record the captured image data and the attribute image data in one file.

With the imaging device disclosed herein, the imaging position can be easily ascertained. Also, with the imaging device disclosed herein, the imaging position can be easily ascertained without connecting to a network.

### BRIEF DESCRIPTION OF THE DRAWINGS

Referring now to the attached drawings, which form a part of this original disclosure:

FIG. 1 is a diagram of the configuration of the front face of a digital camera 100 pertaining to Embodiment 1;

FIG. 2 is a diagram of the configuration of the rear face of the digital camera 100 pertaining to Embodiment 1;

FIG. 3 is a diagram of the electrical configuration of the digital camera 100 pertaining to Embodiment 1;

FIG. 4 is a flowchart showing the flow of processing in imaging mode pertaining to Embodiment 1;

FIG. 5 is a flowchart showing the flow of still picture capture processing pertaining to Embodiment 1;

FIG. 6 is a diagram showing an example of a screen display during still picture reproduction pertaining to Embodiment 1; and

FIG. 7 is a diagram of the electrical configuration of the digital camera 100 pertaining to another embodiment.

### DETAILED DESCRIPTION OF EMBODIMENTS

Selected embodiments of the present technology will now be explained with reference to the drawings. It will be apparent to those skilled in the art from this disclosure that the following descriptions of the embodiments of the present technologies are provided for illustration only and not for the purpose of limiting the technology as defined by the appended claims and their equivalents.

### EMBODIMENT

The digital camera 100 of Embodiment 1 is configured to acquire the position of the digital camera 100. The digital camera 100 acquires map data including the imaging position from a map database during the capture of a still picture, produces map image data (an example of attribute image data), and records image data about the still picture and the map image data in a single file. The configuration and operation of the digital camera 100 will now be described.

### 1. Configuration The configuration of the digital camera 100 will now be described through reference to the drawings.

### 1-1. Configuration of Digital Camera

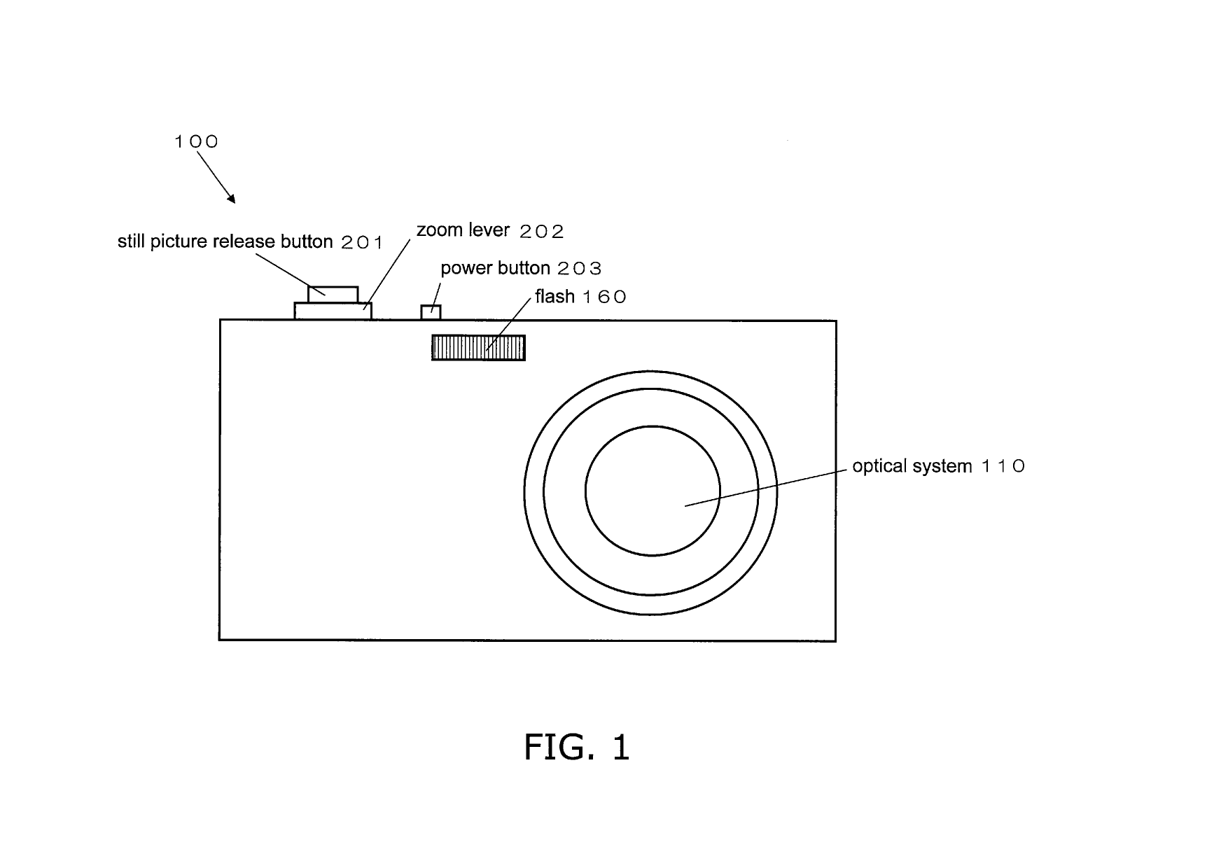

FIG. 1 is a diagram of the configuration of the front face of the digital camera 100. The front face of the digital camera 100 comprises a flash 160 and a lens barrel that contains an optical system 110. The top face of the digital camera 100 comprises a still picture release button 201, a zoom lever 202, a power button 203, and other such control buttons.

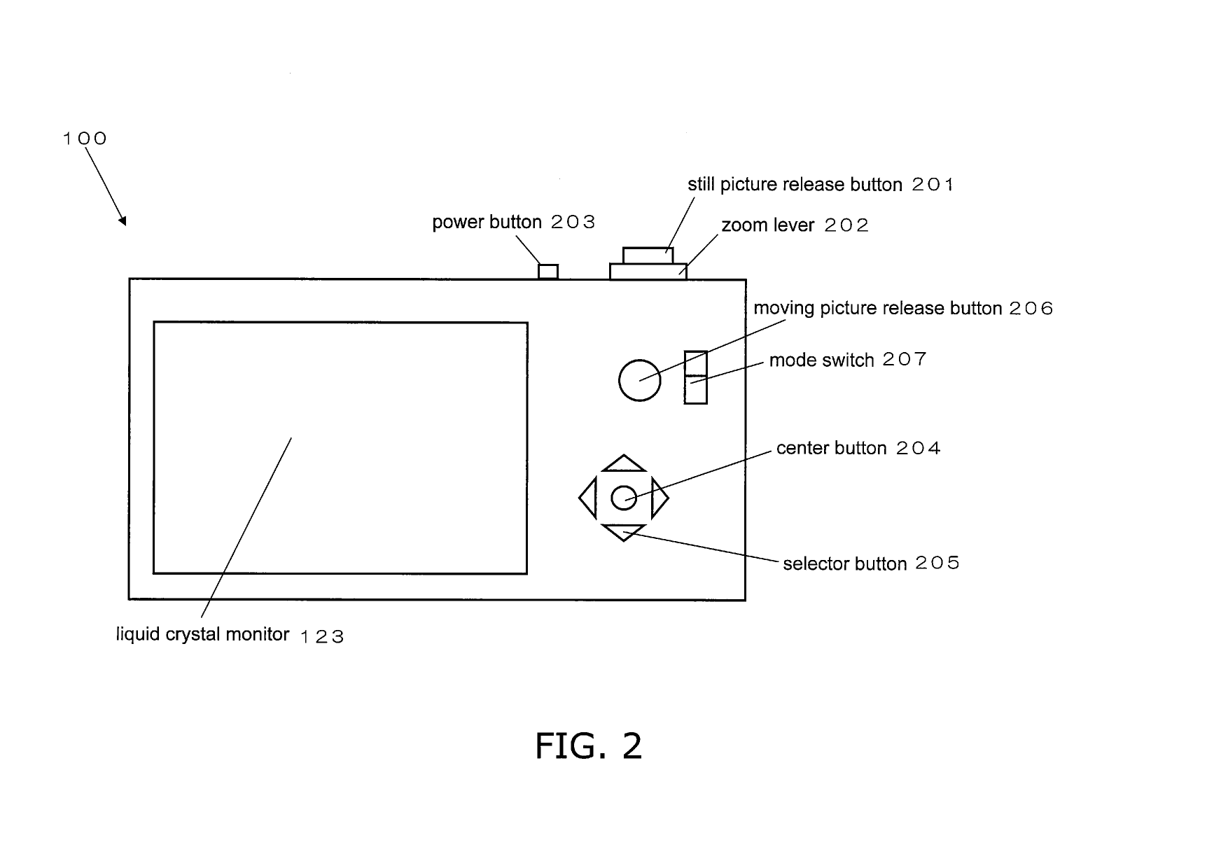

FIG. 2 is a diagram of the configuration of the rear face of the digital camera 100. The rear face of the digital camera 100 comprises a liquid crystal monitor 123, a center button 204, a selector button 205, a moving picture release button 206, a mode switch 207, and so forth.

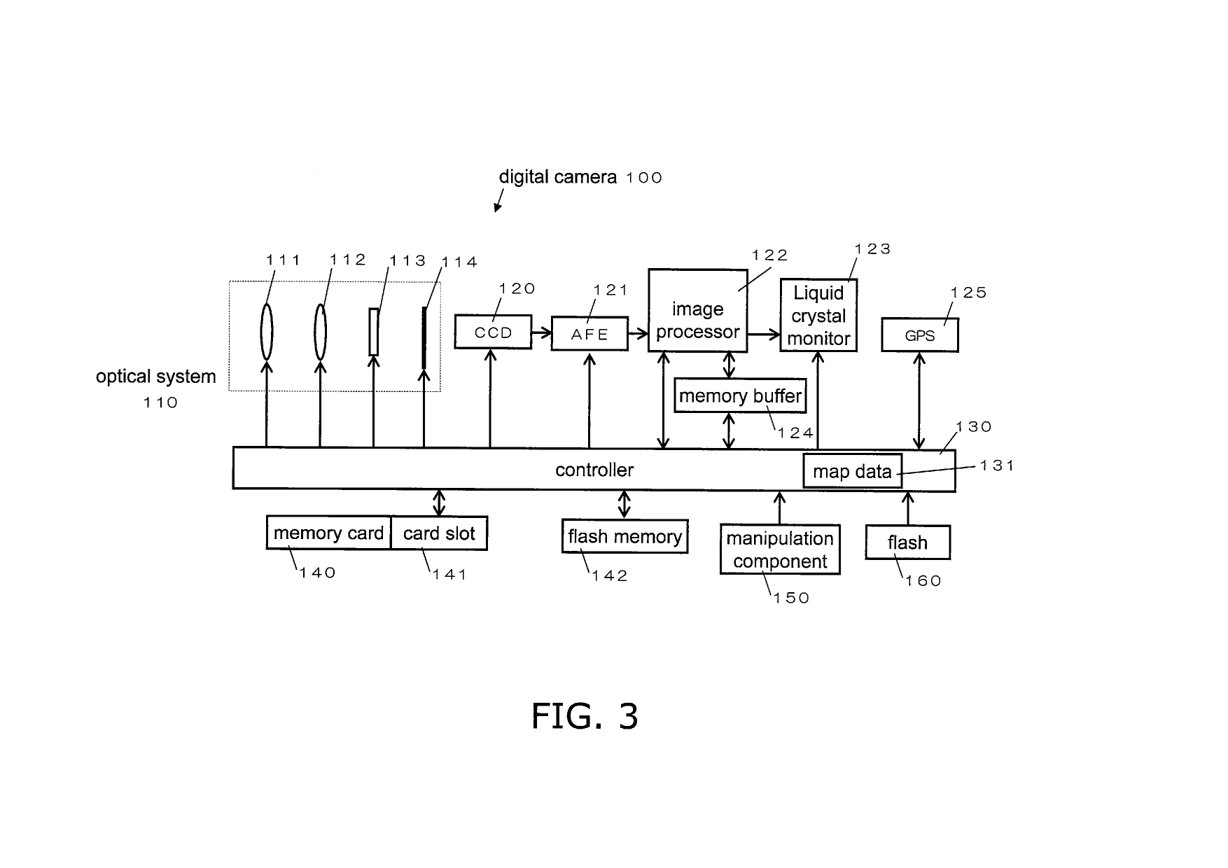

FIG. 3 is a diagram of the electrical configuration of the digital camera 100. With the digital camera 100, a subject image formed via the optical system 110 is captured by the CCD image sensor 120. The CCD image sensor 120 produces image data on the basis of the captured subject image. An AFE (analog front end) 121 and/or an image processor 122 executes various processing for the image data produced by capture. The image data thus produced is recorded to a flash memory 142 or a memory card 140. The image data recorded to the flash memory 142 or the memory card 140 is displayed on the liquid crystal monitor 123 when a manipulation component 150 is operated by the user. The various components shown in FIGS. 1 to 3 will now be described in detail.

The optical system 110 is made up of a focus lens 111, a zoom lens 112, an aperture 113, and a shutter 114. Although not shown in the drawings, the optical system 110 may include an optical blurring correction lens (OIS: optical image stabilizer). Also, the lenses that make up the optical system 110 may each be constituted by a number of lenses, or may be constituted by a number of groups of lenses.

The focus lens 111 is used to adjust the focal state of the subject. The zoom lens 112 is used to adjust the field angle of the subject. The aperture 113 is used to adjust the amount of light that is incident on the CCD image sensor 120. The shutter 114 is used to adjust the exposure time of incident light on the CCD image sensor 120. The focus lens 111, the zoom lens 112, the aperture 113, and the shutter 114 are each driven by a corresponding drive unit such as a DC motor or a stepping motor according to a control signal issued from the controller 130.

The CCD image sensor 120 captures the subject image formed by the optical system 110, and produces image data. The CCD image sensor 120 produces a new frame of image data at specific time intervals when the digital camera 100 is in imaging mode.

The AFE 121 subjects the image data read from the CCD image sensor 120 to various kinds of processing. This processing includes noise suppression by correlated double sampling, amplification to the input range width of an A/D converter by analog gain controller, A/D conversion by A/D converter, and so forth. After this, the AFE 121 outputs the image data to the image processor 122.

The image processor 122 subjects the image data outputted from the AFE 121 to various kinds of processing. Examples of the various processing include smear correction, white balance correction, gamma correction, YC conversion processing, electronic zoom processing, compression processing, and expansion processing, but this list is not comprehensive. The image processing unit 122 records the image information that has undergone the various processing to a memory buffer 124. The image processor 122 may be a hard-wired electronic circuit, or may be a microprocessor that is controlled by programs. Also, the image processor 122 may be constituted by a single semiconductor chip along with the controller 130, etc.

The liquid crystal monitor 123 is provided to the rear face of the digital camera 100. The liquid crystal monitor 123 displays images on the basis of the image data processed by the image processor 122. The images displayed by the liquid crystal monitor 123 include through-images and recorded images. A through-image is an image in which new frames of image data produced at specific time intervals by the CCD image sensor 120 are displayed continuously. Usually, when the digital camera 100 is in imaging mode, the image processor 122 produces a through-image on the basis of the image data produced by the CCD image sensor 120. The user can capture an image while checking the composition of the subject by referring to the through-image displayed on the liquid crystal monitor 123. A recorded image is an image that is reduced to a lower resolution for displaying the high-resolution image data recorded to the memory card 140, etc., on the liquid crystal monitor 123 during reproduction. The high-resolution image data recorded to the memory card 140 is produced by the image processor 122 on the basis of image data produced by the CCD image sensor 120 after the user has operated the release button 201.

The GPS (global positioning system) module 125 receives a signal from a GPS satellite, and uses the received signal to calculate information about the position of the digital camera 100. Calculating position information by using a received signal is called “positioning.” In a state in which the power has been switched on to the digital camera 100, the GPS module periodically performs positioning, and notifies the controller 130 at the point when positioning is executed. Upon receiving this notification, the controller 130 acquires position information as the positioning result from the GPS module 125. The controller 130 then stores this position information in the memory buffer 124.

The controller 130 controls the overall operation of the entire digital camera 100. The controller 130 records the image data stored in the memory buffer 124 after processing by the image processor 122, to the memory card 140 or another such recording medium. The controller 130 is constituted by a ROM that holds programs, information of a map database 131 (discussed below), or other such information, a CPU that processes various information by executing programs, and so forth. The ROM stores programs related to file control, auto focus control (AF control), automatic exposure control (AE control), light emission control over the flash 160, and so on. The ROM also stores programs for the overall control of the operation of the entire digital camera 100.

The map database 131 is data included in the ROM of the controller 130. The controller 130 produces map image data by reading the necessary map data from the map database 131 using the scale and site designated by the position information. The map image data is displayed on the liquid crystal monitor 123. Also, the map image data is stored as image data along with captured images.

The controller 130 may be constituted by a hard-wired electronic circuit, or may be a microprocessor, etc. The controller 130 may also be constituted by a single semiconductor chip along with the image processor 122, etc. Also, the ROM does not need to be an internal component of the controller 130, and may be provided externally to the controller 130.

The memory buffer 124 is a memory unit that functions as a working memory for the image processing unit 122 and the controller 130. In this embodiment, the buffer memory 124 is a DRAM (dynamic random access memory) or the like. The flash memory 142 also functions as an internal memory for recording image data and setting information or the like about the digital camera 100.

A card slot 141 is a connecting unit that allows the memory card 140 to be inserted and removed. The card slot 141 allows the memory card 140 to be electrically and mechanically connected to the digital camera 100. The card slot 141 may also comprise a function of controlling the memory card 140.

The memory card 140 is an external memory that has recording component such as a flash memory in its interior. The memory card 140 records data such as image data processed by the image processor 122.

The manipulation component 150 is a generic term used to refer to control buttons, control dials, and so forth provided to the exterior of the digital camera 100. The manipulation component 150 is operated by the user. As shown in FIGS. 1 and 2, for example, the manipulation component 150 includes the still picture release button 201, the moving picture release button 206, the zoom lever 202, the power button 203, the center button 204, the selector button 205, the mode switch 207, etc. The manipulation component 150 sends various operating command signals to the controller 130 when operated by the user.

The still picture release button 201 is a two-stage push button that can be pushed half-way down or all the way down. When the still picture release button 201 is pressed half-way down by the user, the controller 130 executes AF (auto focus) control and AE (auto exposure) control and decides on the imaging conditions. Then, when the still picture release button 201 is pressed all the way down by the user, the controller 130 performs imaging processing. The controller 130 records the image data captured at the point when the button was pressed all the way down as a still picture to the memory card 140, etc. Hereinafter, when it is said simply that the still picture release button 201 is pressed, it shall indicate that it was pressed all the way down.

The moving picture release button 206 is a push button for starting and ending moving picture recording. When the moving picture release button 206 is pressed by the user, the controller 130 successively records the image data produced by the image processor 122 as a moving picture to the memory card 140, etc., on the basis of the image data produced by the CCD image sensor 120. When the moving picture release button 206 is pressed again, the recording of the moving picture ends.

The zoom lever 202 is a lever for adjusting the field angle between the wide angle end and the telephoto end, and is a type that automatically returns to its center position. When operated by the user, the zoom lever 202 sends the controller 130 an operating command signal for driving the zoom lens 112. Specifically, when the zoom lever 202 is operated to the wide angle end side, the controller 130 drives the zoom lens 112 so that the subject is captured in wide angle. Similarly, when the zoom lever 202 is operated to the telephoto end side, the controller 130 drives the zoom lens 112 so that the subject is captured in telephoto.

The power button 203 is a push button for switching the supply of power on and off to the various components of the digital camera 100. When the power button 203 is pressed by the user when the power is off, the controller 130 supplies power to the various components of the digital camera 100, and actuates these components. When the power button 203 is pressed by the user when the power is on, the controller 130 halts the supply of power to the various components.

The center button 204 is a push button. When the digital camera 100 is in imaging mode or reproduction mode, and the center button 204 is pressed by the user, the controller 130 displays a menu screen on the liquid crystal monitor 123. A menu screen is a screen for setting various conditions for imaging and reproduction. The information set on the menu screen is recorded to the flash memory 142. When pressed while a setting category of the various conditions has been selected, the center button 204 functions as an enter button.

The selector button 205 consists of push buttons provided in the left, right, up, and down directions. The user can select various condition categories displayed on the liquid crystal monitor 123 by pressing the selector button 205 in one of these directions.

The mode switch 207 is a push button provided in the up and down directions. The user can switch the state of the digital camera 100 between imaging mode and reproduction mode by pressing the mode switch 207 in one of these directions.

The CCD image sensor 120 is an example of an imaging component. The GPS module 125 is an example of a position acquisition component. The controller 130 is an example of an attribute image data acquisition component. The controller 130 is also an example of a recorder.

### 2. Operation

### 2-1. Imaging Operation of Digital Camera

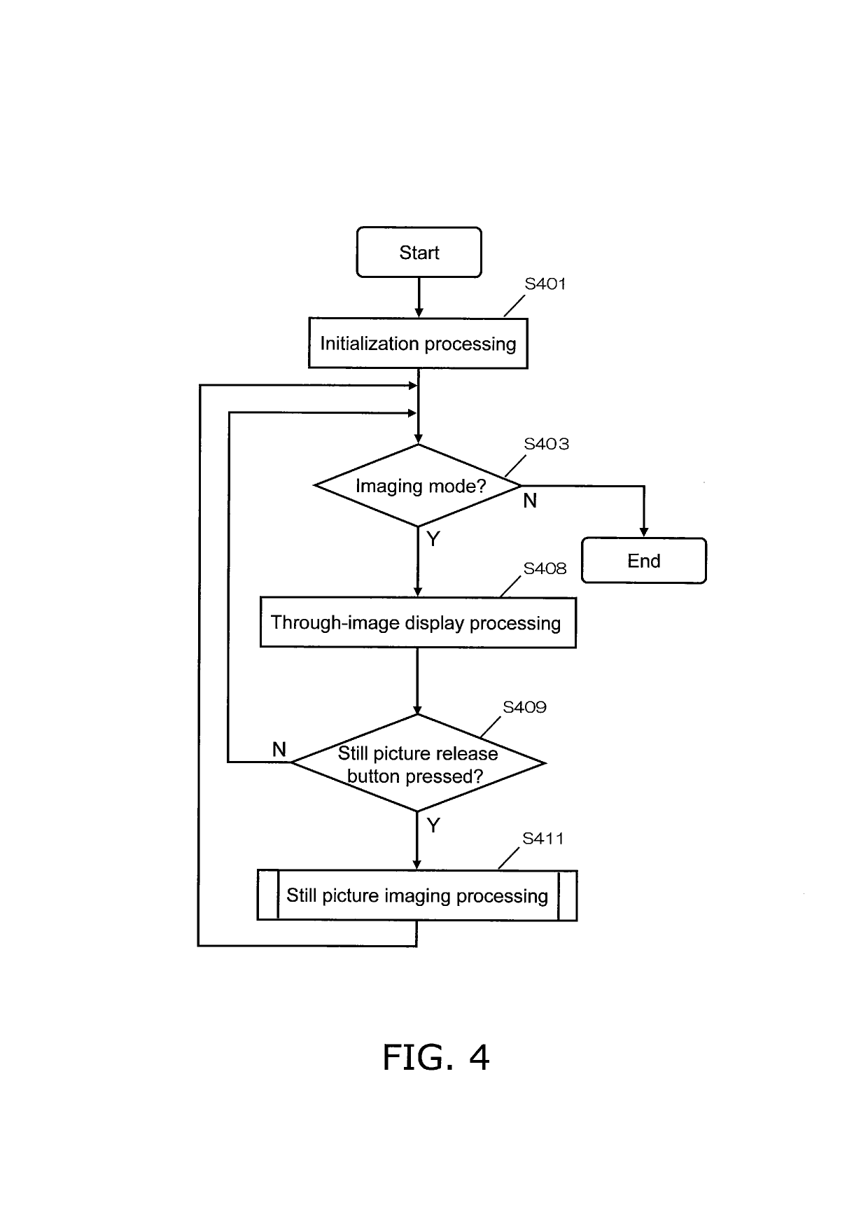

Imaging control with the digital camera 100 will be described. The digital camera 100 performs processing to merge the image data that has been captured (hereinafter referred to as captured image data) and the map image data around the imaging site (which is ancillary data to the captured image data) into a single file. FIG. 4 is a flowchart of imaging control when the digital camera 100 is in imaging mode. The capture of a still picture will be described here. The digital camera 100 can also capture moving pictures in imaging mode, and not just still pictures.

The controller 130 performs the initialization processing necessary for still picture recording when the digital camera 100 has been changed to imaging mode by operation of the mode switch 207 by the user (S401). In this initialization processing, the initialization processing necessary for recording is executed, and actuation processing of the GPS module 125 is executed. When actuation processing of the GPS module 125 is executed, the GPS module 125 periodically calculates position information in the background, and sends this position information to the controller 130. Upon receiving this notification from the GPS module 125, the controller 130 stores the calculated position information in the memory buffer 124. The calculated position information is recorded in the file which is produced when the captured image data is recorded.

Upon completion of the initialization processing, the controller 130 repeats user input confirmation processing and display processing. The user input confirmation processing and display processing include confirmation of the state of the mode switch 207 (S403), display of a through-image (S408), and monitoring of whether the still picture release button 201 has been pressed (S409).

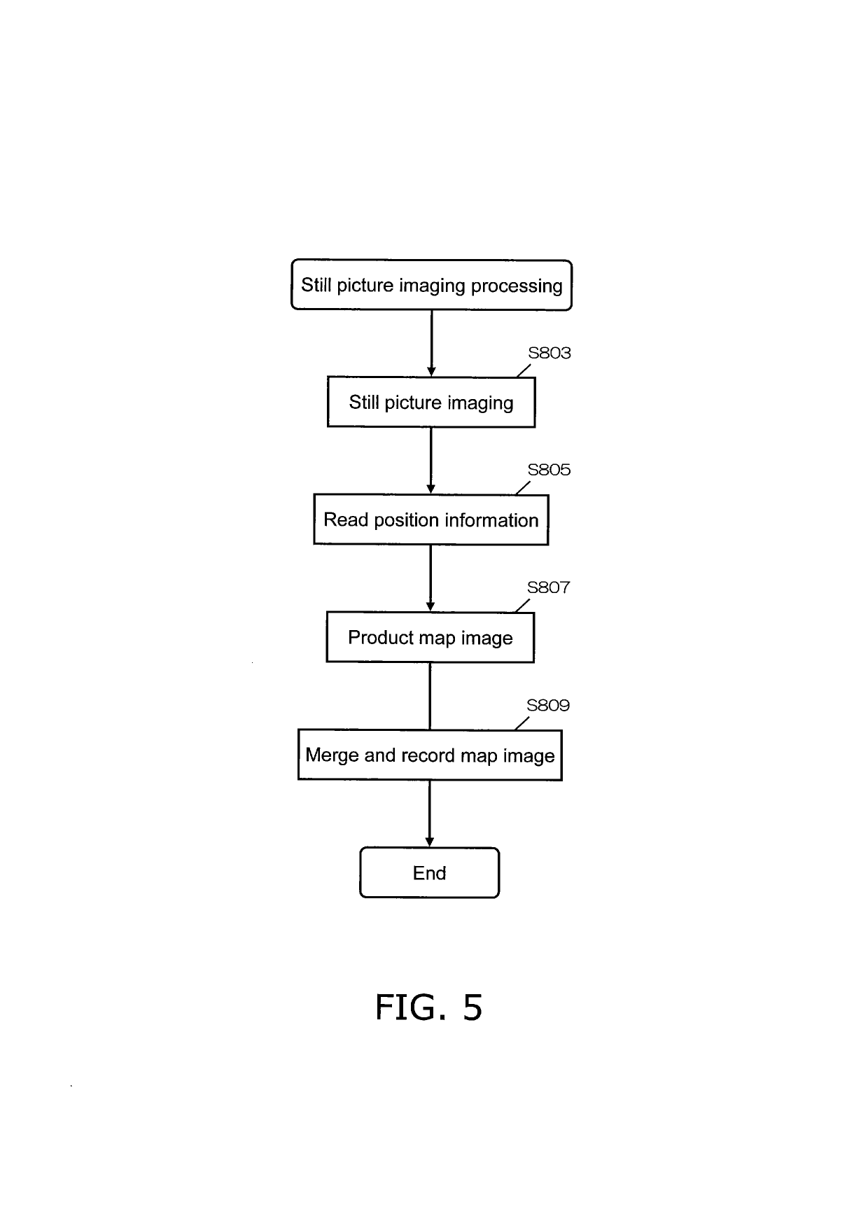

In step S403, if the state of the mode switch 207 is not imaging mode, the controller 130 ends the processing of imaging mode. The controller 130 performs through-image display processing according to the setting value that is currently set (S408). If it is detected in step S409 that the still picture release button 201 has been pressed, still picture imaging processing is performed (S411). Details of the still picture imaging processing will be discussed later through reference to the flowchart in FIG. 5.

If it is not detected in step S409 that the still picture release button 201 has been pressed, the controller 130 repeatedly executes the processing from step S403. When the still picture imaging processing of step S411 ends, the controller 130 repeatedly executes the processing from step S403.

FIG. 5 is a flowchart showing the flow of still picture imaging processing. If it is detected that the user has pressed the still picture release button 201, the controller 130 stores the still picture produced by the image processor 122 as captured image data in the memory buffer 124 on the basis of the image data produced by the CCD image sensor 120 at the point when the still picture release button 201 was pressed (S803). Next, the controller 130 reads GPS position information from the memory buffer 124 to utilize it as information about the imaging site (S805). The controller 130 then produces map image data that is stored along with the captured image data based on the position information read from the memory buffer 124 (S807). More specifically, the controller 130 reads map data centered on position information from the map database 131, and produces map image data according to the specified scale and data size. A picture quality of the map image data here is set such that the imaging site and its surrounding map are confirmed. Even though the captured image data includes map image data, the file size is reduced by making the resolution and size of the map image data smaller than those of the captured image data.

Here, an example was given of a case in which the setting information for the map image data (e.g., imaging site, scale, and data size) were already set, but the setting information may be selected by the user before or during imaging.

Finally, the controller 130 stores the map image data and the captured image data in a single file, and records this file to a recording medium such as the memory card 140 (S809). For example, the captured image data and map image data may be stored in a single file using MPO (multi-picture object) as the format. When MPO format is used, the captured image data and map image data are in a mutually independent relation. Accordingly, the MPO-format file is defined by treating the captured image data and map image data as a main image and as an “undefined” image type, respectively.

Also, for example, when MPO format is used to store captured image data and map image data in a single file, the format type of the captured image data and map image data may be JPEG format. Also, if compatibility with JPEG format is given preference in the file for storing the captured image data and map image data, the map image data may be embedded in an EXIF (exchangeable image file format) header. In this case, the captured image data can be reproduced by more devices. Also, with a device that can read map image data included in an EXIF header, the map image data can be read directly.

As discussed above, if captured image data is stored in a single file along with the map image data produced as ancillary data to the captured image data, there will be no need to separately produce a management information file for managing association between sets of image data, etc. Also, based on its purpose, there is little need for the map image data (ancillary data) to be a high-quality image. Therefore, the produced file size can be suppressed by making the resolution and size of the map image data smaller than those of the captured image data. Also, if the map image data including the site where the captured image data was captured is recorded along with the captured image data, even though the user cannot access an external map server or the like, the site where the captured image data was captured can be confirmed on the map merely by displaying the map image data in this file. In this case, since the imaging site and the area around the imaging site can be simultaneously confirmed on the map, it is easier at a later date to remember the site where the captured image data was captured.

### 2-2. Reproduction Operation of the Digital Camera

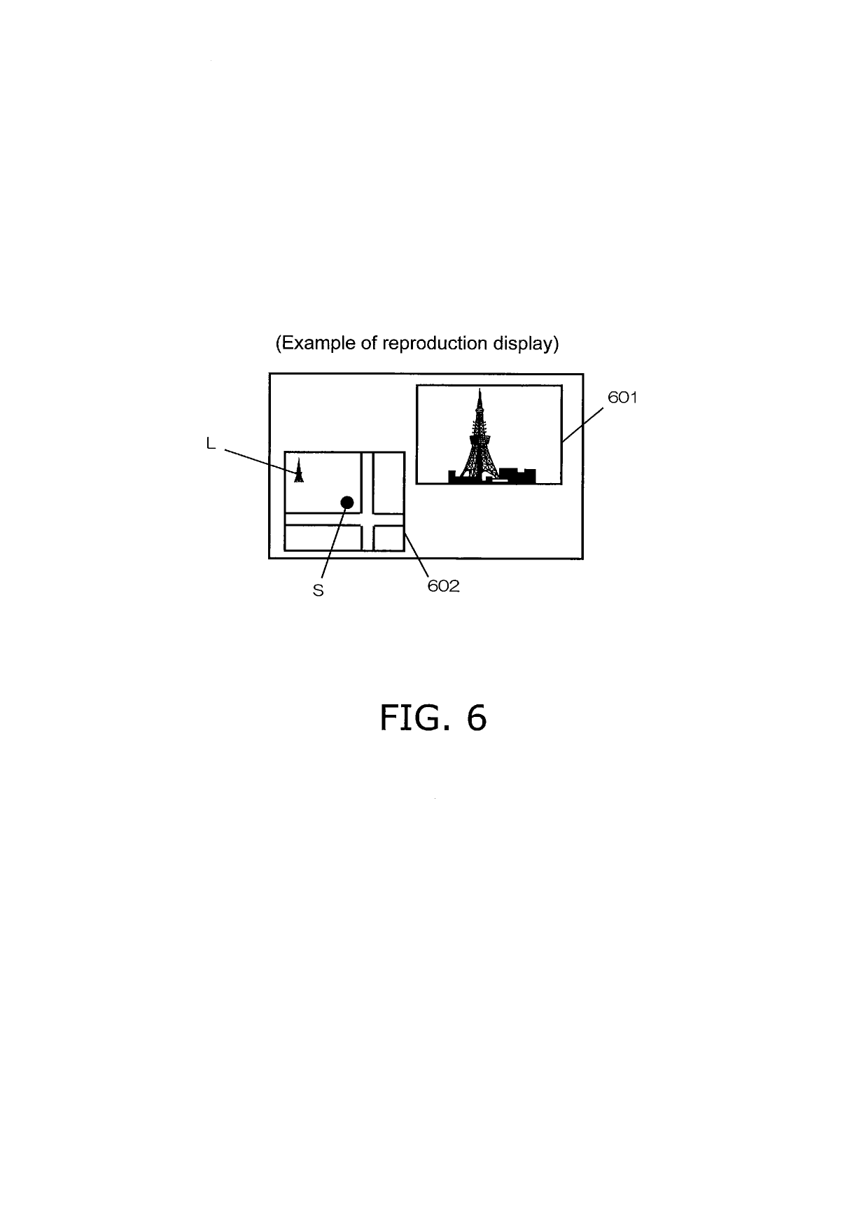

The reproduction operation of the digital camera 100 will be described. The digital camera 100 reads from the memory card 140 a file obtained by recording a plurality of sets of image data recorded in step 5809 as a single file, and displays this file on the liquid crystal monitor 123. More specifically, the controller 130 reads this file from the memory card 140, and expands in the memory buffer 124 captured image data and the map image data included in this file. Then, the captured image data and map image data expanded in the memory buffer 124 are arranged and displayed on the liquid crystal monitor 123. FIG. 6 shows an example of when this file is read during reproduction and displayed on the liquid crystal monitor 123.

A captured image 601 is an image corresponding to the captured image data produced by the digital camera 100. An ancillary data image 602 is an image corresponding to the map image data produced by utilizing the map database 131 during imaging. As to the display ratio when an image is displayed, the display size may be determined using the pixel ratio as a reference.

### 3. Conclusion

As discussed above, the digital camera 100 in this embodiment comprises the CCD image sensor 120, the GPS module 125, and the controller 130. The CCD image sensor 120 captures a subject and outputs captured image data. The GPS module 125 acquires the position where the subject was captured. The controller 130 acquires map image data including the above-mentioned position as ancillary image data from the map database. Also, the controller 130 records the captured image data and the ancillary image data as a single file.

With this constitution, the captured image data and the map image data (ancillary data to the captured image data) can be merged into a single file. Therefore, during reproduction, the captured image and ancillary image can be displayed on the liquid crystal monitor 123 as a set of a captured image and ancillary data. Also, even though the digital camera cannot be connected to a network, the captured image and ancillary image can be displayed on the liquid crystal monitor 123 by reproducing this file. Furthermore, if there is an image on another terminal, related information can be easily displayed without dealing with a management information file or the like as long as the merged file format is compatible.

### OTHER EMBODIMENTS

The technology disclosed herein is not limited to or by the above embodiment, and various other embodiments are conceivable. A non-exhaustive list of other embodiments will be given below.

(A) In the above embodiment, an example was given in which the map image data is recorded as ancillary data, but the ancillary data may be some other data. In that case, the controller 130 first displays a menu screen for merging ancillary data with captured image data on the liquid crystal monitor 123. Then, the controller 130 may merge the image data (ancillary data) selected by the user with the captured image data on the menu screen. More specifically, first the captured image data is temporarily recorded by itself. Then, on a photograph merge menu, the user selects the image data to be merged with the captured image data. Finally, these sets of image data are merged. Consequently, just as in Embodiment 1, captured image data and ancillary data can be compiled in a single file.

Also, another method for merging ancillary data besides map image data may be to merge during imaging. More specifically, first imaging is executed and captured image data is produced. Then, the capture of ancillary data is performed. Finally, a single file is formed by merging these two. For example, after capturing a landscape or a building, a sign or pamphlet on which a related explanation is written is captured, thereby recording these sets of image data as a single file.

(B) In the above embodiment, an example was given in which there was only one set of ancillary data, but a plurality of sets of ancillary data may be used. In this case, image selection (or capture) of a plurality of sets of ancillary data is executed by the user. When a map image is used as the ancillary data, map images produced in a plurality of scales may also be merged.

(C) In the above embodiment, an example was given in which captured image data and ancillary data (map image data) were merged into a single file. Instead of this, map image data may be uploaded to the Internet, etc., and a URL (uniform resource locator) may be recorded as ancillary data to the captured image data. In this case, during reproduction, the uploaded image data may be downloaded from the URL and displayed, or the URL may be displayed on the liquid crystal monitor 123 to notify whether or not there is ancillary data. For instance, when the map indicated by the map image data includes a landmark, the ancillary data may include site information, name information, sightseeing information, or the like for this landmark.

(D) In the above embodiment, an example was given in which the scale of the map image data was a specific value, but the scale of the map image data may be determined by taking into account surrounding landmarks. For example, position information is acquired from the flash memory 142 when imaging is performed. Landmark information at the position closest to this position information is retrieved from the map database 131. The scale is chosen so that the site indicated by the position information (the imaging site) and the position of a landmark L will both be on the map, and map data including both is extracted. This function is assumed by the controller 130 (an example of a landmark information acquisition component). Consequently, when a map image is displayed, an imaging site S and the closest landmark L are displayed at the same time (see FIG. 6). Accordingly, when the user checks the map, it will be easy to ascertain the place where the image was captured.

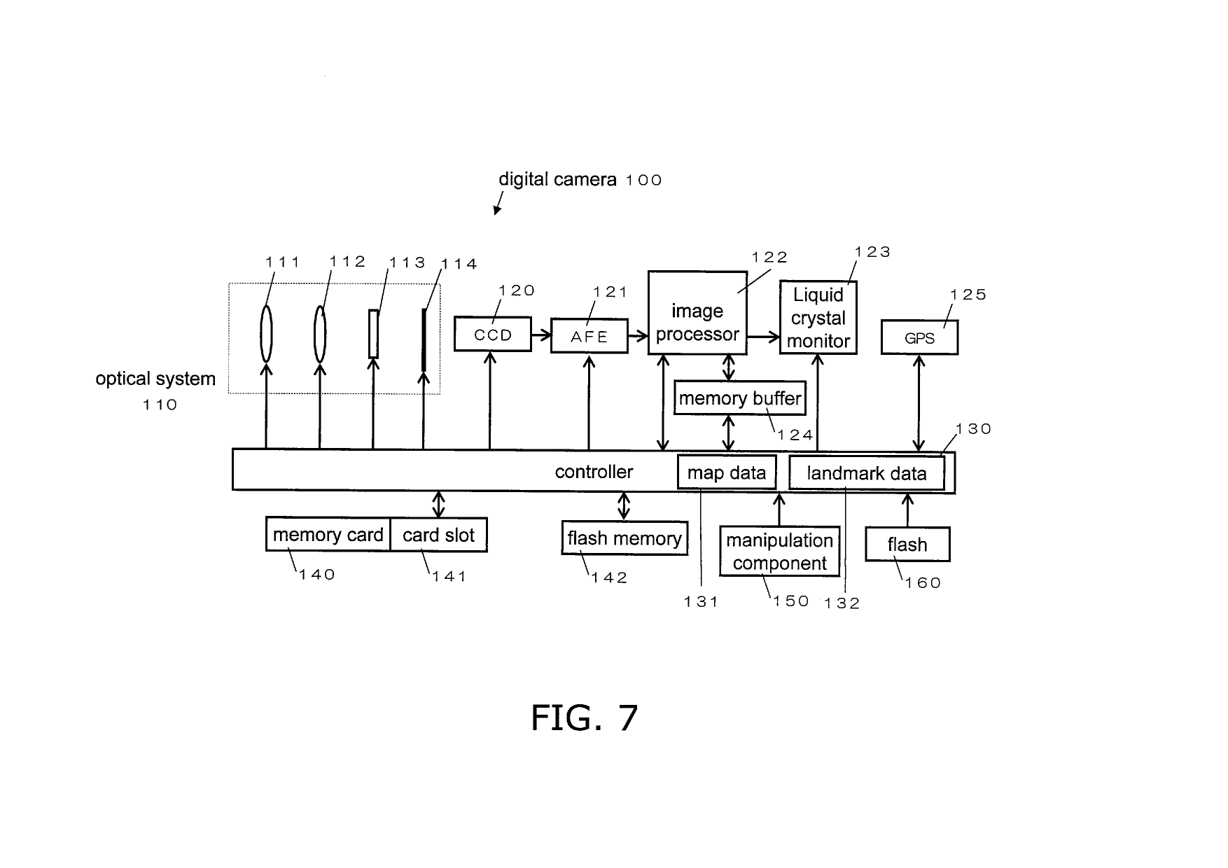

(E) In the above embodiment, an example was given in which the scale of the map image data was a specific value, but the scale of the map image data may be determined by taking into account surrounding landmarks. For example, as shown in FIG. 7, position information is acquired from the flash memory 142 when imaging is performed. Landmark information at the position closest to this position information is retrieved from the map database 131. A landmark attribute (such as distant view or close-up view) corresponding to this landmark information is then recognized by the controller 130 on the basis of a landmark database 132. The scale of the map image data is thus set on the basis of the landmark attribute. This function is assumed by the controller 130 shown in FIG. 7 (an example of a landmark information acquisition component). The configuration in FIG. 7 is the same as that in FIG. 3 other than the landmark database 132. Those components that are the same are numbered the same.

For example, if certain landmark information is detected, the controller 130 recognizes whether the landmark indicated by this landmark information has a distant view attribute or a close-up view attribute. If the landmark attribute is a close-up view attribute, then the scale of the map image data is set so that the map will be a wide area map. On the other hand, if the landmark attribute is a distant view attribute, the scale of the map image data is set so that the map will be a detail map.

Consequently, when a map image is displayed, the imaging site S and the closest landmark L are simultaneously displayed (FIG. 6 is an example of a wide area map). Accordingly, when the user checks the map, it will be easy to ascertain the place where the image was captured.

The landmark database 132 is stored in the ROM of the controller 130. Also, the landmark information and landmark attribute are associated with one another.

(F) In the above embodiment, an example was given in which the captured image data was a still picture, but the captured image data may be a moving picture instead. In this case, the map image data that is recorded along with the captured image data (captured moving picture data) may be a map indicating the site where the capture of the moving picture starts, or a map indicating where the capture ends. Also, this map image data may be a map such that position information is acquired at specific time intervals during imaging, and at least one of a plurality of sites is included.

### GENERAL INTERPRETATION OF TERMS

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of the imaging device. Accordingly, these terms, as utilized to describe the present technology should be interpreted relative to the imaging device.

The term “configured” as used herein to describe a component, section, or part of a device implies the existence of other unclaimed or unmentioned components, sections, members or parts of the device to carry out a desired function.

The terms of degree such as “substantially”, “about” and “approximately” as used herein mean a reasonable amount of deviation of the modified term such that the end result is not significantly changed.

While only selected embodiments have been chosen to illustrate the present technology, it will be apparent to those skilled in the art from this disclosure that various changes and modifications can be made herein without departing from the scope of the technology as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further technologies by the applicant, including the structural and/or functional concepts embodied by such feature(s). Thus, the foregoing descriptions of the embodiments according to the present technologies are provided for illustration only, and not for the purpose of limiting the technology as defined by the appended claims and their equivalents.

### INDUSTRIAL APPLICABILITY

The technology disclosed herein can be applied to an imaging device with which the imaging position can be more easily ascertained. For instance, it can be applied to a digital still camera, a movie camera, a portable telephone, a smart phone, a mobile PC, or the like.

What is claimed is:

1. An imaging device comprising:
an imaging component configured to capture a subject and output captured image data;
a position acquisition component configured to acquire a position of the subject, the subject being captured at the position;
an attribute image data acquisition component configured to acquire map image data as attribute image data from a map database, the map image data including the position of the subject; and
a recorder configured to record the captured image data and the attribute image data in one file.

2. The imaging device according to claim 1, wherein:
a format of the file is a multi-picture format.

3. The imaging device according to claim 1, wherein:
the attribute image data acquisition component sets a number of pixels of the attribute image data to be lower than a number of pixels of the captured image data.

4. The imaging device according to claim 1, further comprising:
a landmark information acquisition component configured to acquire landmark information included in a specific range with the position of the subject as a reference, from the map database, wherein:
the attribute image data acquisition component acquires the map image data from the map database on a basis of the position of the subject and the landmark information.

5. The imaging device according to claim 4, wherein:
the map image data acquired by the attribute image data acquisition component includes the position of the subject and a position of the landmark information.

6. The imaging device according to claim 4, wherein:
the attribute image data acquisition component acquires the map image data from the map database on the basis of the position of the subject and an attribute of the landmark information, the attribute being a feature that the landmark information includes.

7. An imaging device comprising:
an imaging component configured to capture a subject and output one or more sets of captured image data produced in a single operation;
an attribute image data acquisition component configured to acquire image data as attribute image data, the acquired image data being different from the one or more sets of captured image data produced in the single operation; and
a recorder configured to record the one or more sets of captured image data and the attribute image data in one file.

8. An imaging device comprising:
a storage component configured to store a map database;
an imaging component configured to capture a subject and output image data of the captured subject;
a position acquisition component configured to acquire a position of the imaging device at a time when the subject is captured by the imaging component;
an attribute image data acquisition component configured to acquire map image data as attribute image data from the map database stored in the storage component, the map image data including the position of the imaging device; and
a recorder configured to record the image data of the captured subject and the attribute image data in a single file.

9. The imaging device according to claim 8, further comprising:
a landmark information acquisition component configured to acquire landmark information, which is included within a specific range of the position of the imaging device, from the map database stored in the storage component, wherein:
the attribute image data acquisition component acquires the map image data from the map database on a basis of the position of the imaging device and the landmark information.
